(19) United States
(12) Patent Application Publication
(10) Pub. No.: US 2022/0180344 A1
(43) Pub. Date: Jun. 9, 2022

(54) SIMULATED ACCOUNT BASED ON A REAL WORLD ACCOUNT

(71) Applicant: Capital One Services, LLC, Mclean, VA (US)

(72) Inventors: Allison FENICHEL, Brooklyn, NY (US); John Oliva GILLING, Brooklyn, NY (US); Hao WANG, Jersey City, NJ (US)

(21) Appl. No.: 17/111,887

(22) Filed: Dec. 4, 2020

(51) Int. Cl. G06Q 20/22; G06Q 20/08

(52) U.S. Cl. CPC G06Q 20/2295; G06Q 40/02; G06Q 20/0855

(57) ABSTRACT

In some implementations, a device may receive an indication to create a child account that is associated with the parent account, wherein the parent account is associated with a first entity and the child account is associated with a second entity, and wherein the child account does not have independent resources for completing electronic exchanges. The device may create the child account based on information associated with the parent account. The device may provide information associated with the child account to a platform that enables the second entity to access and interact with the information associated with the child account, wherein the information associated with the child account includes account details associated with the parent account and one or more transactions completed using resources of the parent account.

### BACKGROUND

A simulation is an approximate imitation of the operation of a process or system that represents its operation over time. Simulation is used in many contexts, such as simulation of technology for performance tuning or optimizing, safety engineering, testing, training, education, and/or games. Simulation can be used to show the eventual real effects of alternative conditions and courses of action.

### SUMMARY

In some implementations, a system for simulating an environment based on a first account includes one or more memories; and one or more processors, communicatively coupled to the one or more memories, configured to: receive, from a first device associated with a first entity, a request to create a simulated account associated with the first account, wherein the first account is associated with the first entity and the simulated account is associated with a second entity; create the simulated account and a simulated environment associated with the simulated account, wherein the simulated environment includes an interface that enables the second entity to access or interact with information associated with the first account; receive an indication of information associated with the first account that is to be made available to the simulated account, wherein the information includes at least one of: one or more attributes of the first account, or one or more exchanges that are associated with the first account; and provide, to a second device associated with the second entity, the simulated environment associated with the simulated account indicating the information associated with the first account.

In some implementations, a method for simulating a parent account includes receiving, by a device, an indication to create a child account that is associated with the parent account, wherein the parent account is associated with a first entity and the child account is associated with a second entity, and wherein the child account does not have independent resources for completing electronic exchanges; creating, by the device, the child account based on information associated with the parent account; and providing, by the device, information associated with the child account to a platform that enables the second entity to access and interact with the information associated with the child account, wherein the information associated with the child account includes account details associated with the parent account and one or more transactions completed using resources of the parent account.

In some implementations, a non-transitory computer-readable medium storing a set of instructions includes one or more instructions that, when executed by one or more processors of a device, cause the device to: establish, via a server device, a connection with a simulated platform for accessing or interacting with information associated with an account, wherein the information associated with the account includes at least one of account details associated with the account or one or more records associated with the account, wherein the account is associated with a first entity and a credential used to access the simulated platform is associated with a second entity; display, via an interface of the device, the simulated platform indicating the information associated with the account; receive, from the server device, updated information associated with the account; and display, via the interface of the device, the simulated platform indicating the updated information associated with the account.

### BRIEF DESCRIPTION OF THE DRAWINGS

FIGS. 1A-1D are diagrams of an example implementation relating to a simulated account that is based on a real world account.

FIG. 2 is a diagram of an example environment in which systems and/or methods described herein may be implemented.

FIG. 3 is a diagram of example components of one or more devices of FIG. 2.

FIG. 4 is a flowchart of an example process relating to a simulated account that is based on a real world account.

### DETAILED DESCRIPTION

The following detailed description of example implementations refers to the accompanying drawings. The same reference numbers in different drawings may identify the same or similar elements.

In most cases, an individual is not allowed to establish a transaction account until the individual reaches a certain age. For example, an individual may be unable to establish a personal transaction account with an institution until the individual reaches the age of 18. As a result, at the time the individual can establish a personal transaction account, the individual has no hands-on or real world experience managing a transaction account. This can have disastrous effects for the individual because the individual may make uninformed decisions and/or perform actions associated with the transaction account, such as missing payments, exceeding credit limits, accruing interest, and/or having transactions declined, among other examples. This may have negative effects for the individual for an extended period of time. For example, the individual's credit score may be negatively impacted by the uninformed decisions made by the individual, impacting the individual's ability to open additional transaction accounts, reducing the individual's chance to obtain financing (e.g., for a vehicle and/or a home), and/or result in higher interest rates for future transactions accounts and/or loans, among other examples.

Therefore, it may be beneficial to provide experience associated with managing a transaction account to an individual before the individual is able to establish a personal transaction account. In some cases, an individual may take a course or a class on managing transaction accounts. In some cases, an individual may be provided a simulated account and may be enabled to manage the account using simulated transactions. However, gaining experience based on a simulated account (e.g., that does not use real transactions and/or real account information) may be less beneficial than gaining experience based on a real world account and/or real world transactions.

For example, the individual could gain experience based on a parent account (e.g., a real world account). However, it may be difficult to track or maintain transactions and/or information to be made available to the individual. For example, it may be difficult for a device to determine, identify, or distinguish information that is to be made available to the individual. Moreover, it may be difficult to associate certain transactions and/or actions (such as payments towards an account balance) to be performed with the individual without those transactions and/or actions having a real world impact on the parent account (e.g., using resources of the parent account). Allowing such transactions and/or information to be associated with the parent account may result in unauthorized transactions or missed deadlines because the individual has little to no experience in managing a transaction account. This may consume computing resources associated with identifying and/or remedying the unauthorized transactions and/or missed deadlines.

In some cases, another entity (such as a parent or guardian of the individual) may provide real world experience to the individual by granting the individual access to a transaction account associated with the entity. For example, the entity may add the individual as an authorized user of the transaction account. However, transactions and/or actions performed by the individual as an authorized user will be associated with the transaction account of the other entity. For example, the individual may initiate transactions that are completed using resources of the transaction account. As described above, this may result in unauthorized transactions and/or negative impacts associated with the transaction account. This may consume computing resources associated with identifying and/or remedying the unauthorized transactions.

Some implementations described herein enable a simulated account that is based on a real world account. For example, a first entity may request that a simulated account (e.g., a child account associated with a second entity) associated with a parent account (e.g., associated with the first entity) be created. The first entity may indicate information to be made available to the child account, such as one or more real world transactions completed using resources of the parent account, attributes of the parent account (e.g., interest rate, credit limit, account balance, and/or payment or contribution deadlines), and/or resources available to the child account, among other examples. For example, information for one or more transactions made on behalf of the second entity using resources of the parent account may be provided to the child account. In some implementations, the child account may be associated with a transaction device that enables the second entity to make approved transactions and/or initiate transactions that are not completed, but that are tracked and associated with the child account. The second entity may access the child account via a platform that enables the second entity to access and interact with information associated with the parent account.

Moreover, some implementations described herein enable the first entity to selectively share information associated with the parent account. For example, as described above, there may be some information associated with the parent account that the first entity may want to conceal from the child account for security reasons, such as transactions not pertinent to the second entity, an account balance of the parent account, and/or a credit limit or spending limit of the parent account, among other examples. The first entity may indicate the information that is not to be provided to the child account (or only information indicated by the first entity may be shared with the child account). A server device may store and update information of the parent account such that the information that is to be provided to the child account is indicated or otherwise flagged. As a result, an interface may be generated that enables only the information that is to be provided to the child account to be displayed (e.g., on a client device) when credentials (e.g., login credentials) associated with the second entity are used to access the interface. Similarly, an interface may be generated that enables all information associated with the parent account to be displayed (e.g., on a client device) when credentials (e.g., login credentials) associated with the first entity are used to access the interface. Moreover, this enables the first entity to establish multiple child accounts associated with the parent account, with each child account having access to different types of information and/or different amounts of information associated with the parent account. For example, when a second entity accesses the interface or platform associated with the child account, the server device may identify or retrieve the information associated with the parent account that is to be provided to the child account based on the storing and updating of the information of the parent account such that the information that is to be provided to the child account is indicated or otherwise flagged. As a result, selective sharing of information associated with the parent account may be enabled, thereby improving security of the information associated with the parent account that is not to be shared with the child account(s).

Further, the second entity may be enabled to access and interact with a platform for managing a transaction account that provides real world transaction information and/or account information. The second entity may be enabled to initiate and/or complete transactions. The second entity may be enabled to track an account balance (that is based on real world transactions) and make contributions towards the account balance. As a result, the second entity may gain beneficial experience towards managing a transaction account (e.g., based on real world transactions and/or real world account details) without the risk of unauthorized transactions or missed payments, as described above. This may conserve computing resources that would have otherwise been used to identify and/or remedy unauthorized transactions made by the second entity and/or missed payments associated with the parent account, among other examples.

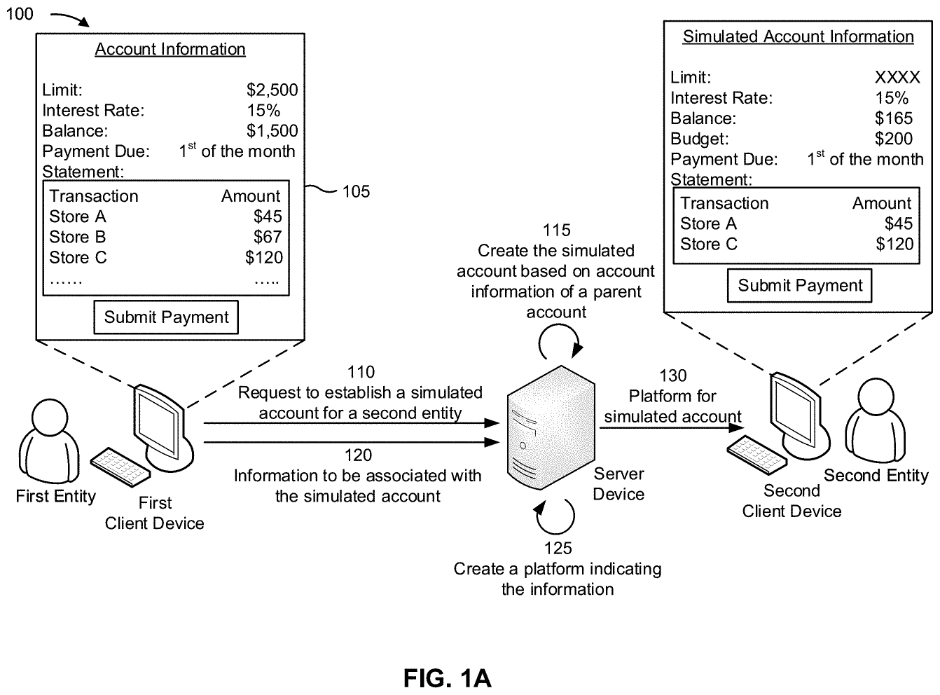

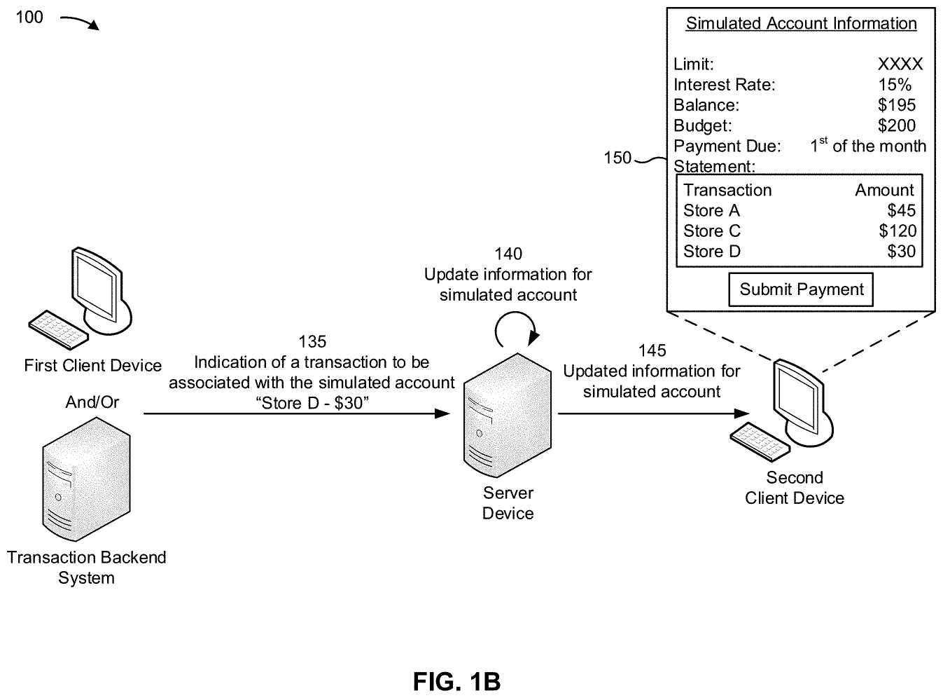

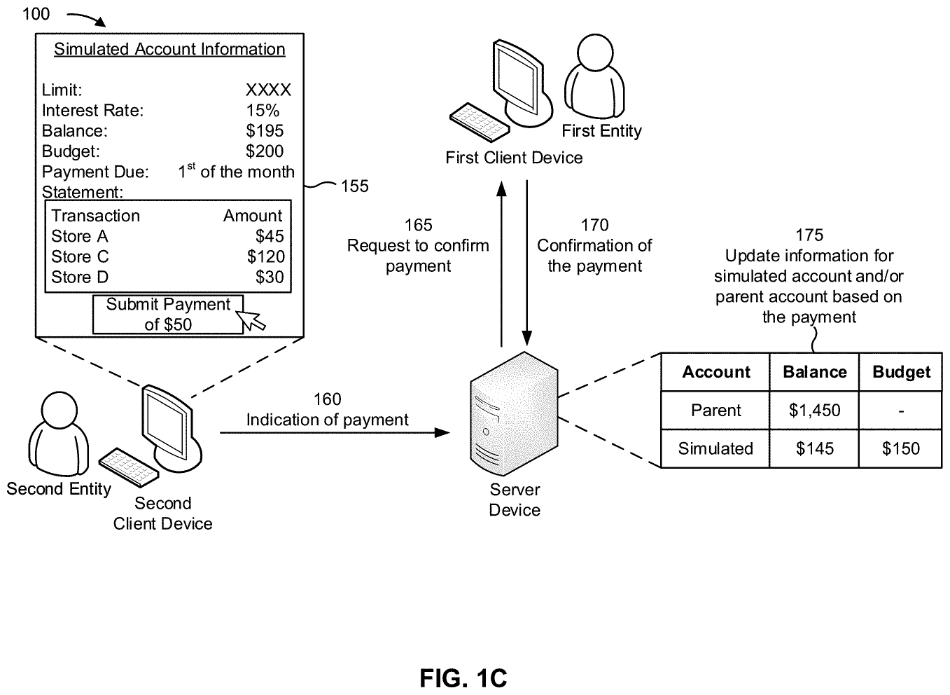

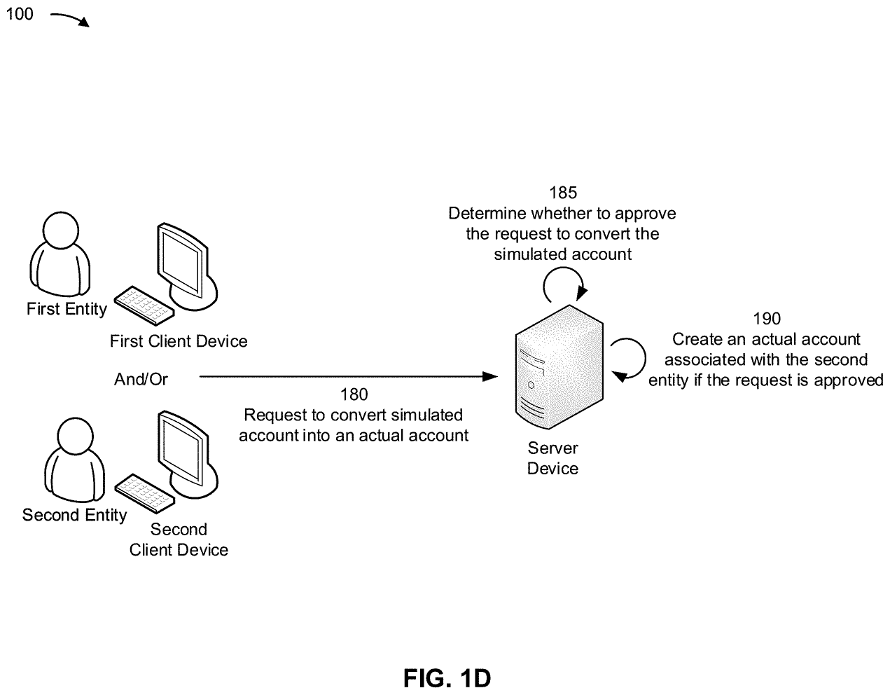

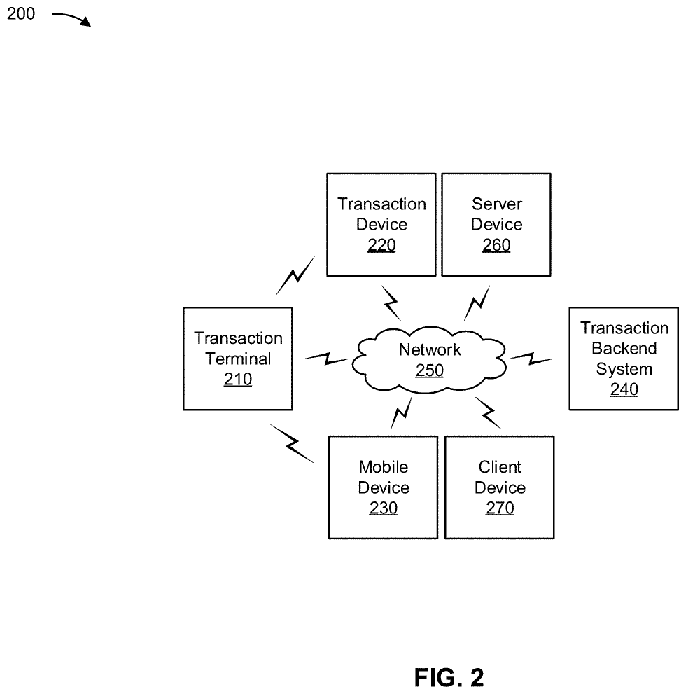

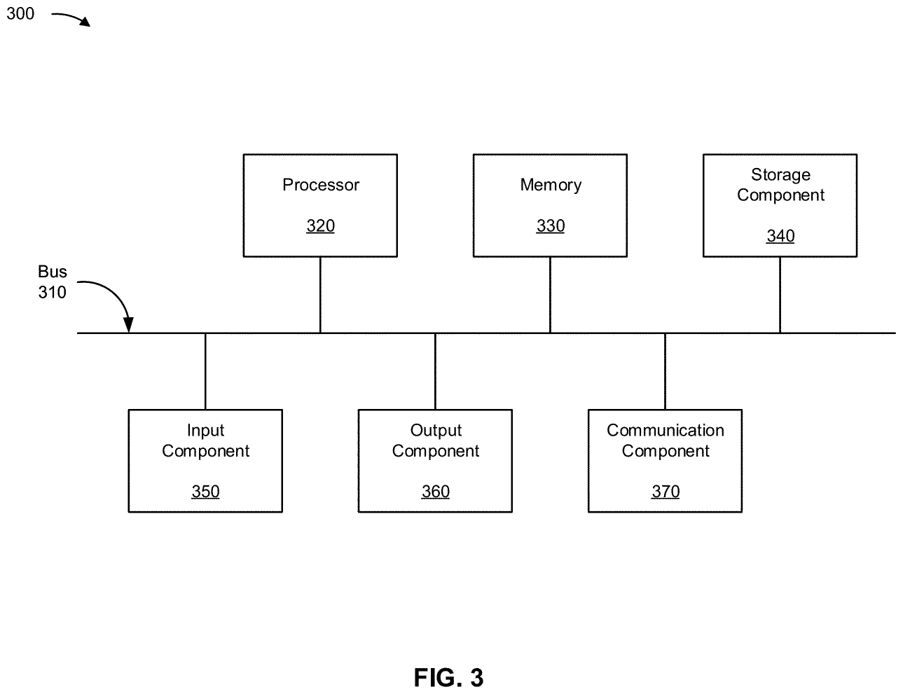

FIGS. 1A-1D are diagrams of an example 100 associated with a simulated account that is based on a real world account. As shown in FIGS. 1A-1D, example 100 includes a server device that communicates with a first client device, a second client device, and/or a transaction backend system. In some implementations, the first client device and the second client device may be the same device that is accessed by different entities (e.g., the first client device may be the client device when accessed by a first entity and the second client device may be the client device when accessed by a second entity). These devices are described in more detail in connection with FIGS. 2 and 3.

As shown in FIG. 1A, and by reference number 105, the first entity (e.g., a first user or person) may be associated with a transaction account. The transaction account may be associated with account information, such as a limit (e.g., a spending limit or a credit limit), an interest rate, an account balance, a payment due date or payment schedule, and/or a statement or record of transactions associated with the transaction account. The transaction account associated with the first entity may be referred to herein as a parent account. The first entity may access and interact with the parent account (e.g., may track transactions and/or submit payments towards an account balance) using the first client device (e.g., via a platform, such as an application or a webpage).

The first entity may request that a simulated account, that is based on the parent account and is associated with a second entity (e.g., a second user or person), be created. For example, the first entity may be a parent or guardian of the second entity. The first entity may wish to create the simulated account to enable the second entity to gain experience managing a transaction account using real world transactions and/or account information. For example, the first entity may complete one or more transactions on behalf of or for the second entity (e.g., the first entity may purchase a toy or a trip for the second entity). The first entity may request that a simulated account be created to enable the second entity to manage the transactions completed by the first entity that are associated with the second entity. In some implementations, the simulated account may be referred to as a child account, a shadow account, or a subsidiary account.

As shown by reference number 110, the first client device may transmit a request to the server device to establish a simulated account for the second entity. The request may indicate that the simulated account is to be based on and associated with the parent account. In some implementations, the request may indicate an identifier associated with the parent account, information associated with the second entity (e.g., name, date of birth, address, email address, and/or social security number), and/or information to be used by the server device to establish the simulated account (e.g., account information for the simulated account, an amount of resources associated with the simulated account, and/or login credentials to be used by the second entity to access account information), among other examples.

In some implementations, the first client device may transmit a request to the server device to establish a second simulated account for a third entity. For example, the first entity may request that a second simulated account, that is based on the parent account and is associated with the third entity (e.g., a third user or person), be created. For example, the first entity may be a parent or guardian of the third entity. In some implementations, the request to the server device to establish the second simulated account for a third entity may indicate information associated with the parent account that is to be made available to the second simulated account. In some implementations, the information that is to be made available to the second simulated account may be the same as the information that is to be made available to the simulated account associated with the second entity. In some implementations, the information that is to be made available to the second simulated account may be different than the information that is to be made available to the simulated account associated with the second entity (e.g., different transactions, different account information, and/or different login credentials to be used by the third entity to access account information). For example, when a simulated account is accessed, as described in more detail below, the server device may identify the simulated account, from multiple simulated accounts associated with the parent account. The server device may identify information that is to be provided (e.g., from the parent account) to the simulated account (e.g., which may be different than information that would be provided to a different simulated account associated with the parent account). In this way, the server device may enable multiple simulated accounts to be associated with the same parent account, with each simulated account have different levels of access to information, or access to different information, associated with the parent account.

As shown by reference number 115, the server device may create the simulated account based on the account information of the parent account and/or information provided in the request to establish the simulated account. For example, the server device may identify the parent account based on an identifier associated with the parent account. The server device may retrieve and/or identify the account information associated with the parent account. The server device may create the simulated account and link or associate the simulated account with the parent account. For example, the server device may link an identifier of the simulated account with the parent account (e.g., in a database). Alternatively, the server device may create the simulated account using the same identifier as the parent account (e.g., the same account number). In some implementations, the server device may create credentials to be used by the second entity to access the simulated account. The server device may provide the credentials to the first entity and/or the second entity (e.g., via the first client device and/or the second client device).

As shown by reference number 120, the client device may transmit an indication of information to be associated with the simulated account (e.g., simulated account information). In some implementations, the indication of the simulated account information may be included in the request to establish the simulated account. The simulated account information may include an indication to use the real (e.g., actual) account information associated with the parent account (e.g., that is stored by the server device). For example, the parent account may be associated with an interest rate of 15%. The first entity may input, via the client device, that the simulated account is to be associated with the same interest rate as the parent account (e.g., 15%). In some implementations, the first entity may input, via the client device, account information for the simulated account that is different than the account information of the parent account. For example, the simulated account information may include a limit (e.g., a credit or spending limit), an interest rate, a budget or allowance, and/or a payment due date or payment schedule, among other examples, that is input by the first entity.

In some implementations, the server device may determine and/or identify some (or all) of the simulated account information without an indication from the first client device. For example, the server device may identify some (or all) of the simulated account information based on parent account information stored by the server device. This may reduce an amount of time associated with establishing the simulated account and reduce computing resources and/or network resources that would otherwise be used (by the first client device and/or the server device) to communicate the simulated account information. In some implementations, the client device may transmit an indication of information associated with the parent account that is not to be made available to the simulated account, such as a limit of the parent account and/or an account balance of the parent account, among other examples.

The information to be associated with the simulated account may include an indication of one or more transactions associated with the parent account that are to be associated with the simulated account. The first entity may indicate one or more transactions that are to be associated with the simulated account. For example, as shown in FIG. 1A, the first entity may complete a transaction at Store A for $45, Store B for $67, and store C for $120. The transactions at Store A and Store C may have been associated with the second entity (e.g., the transactions may have been for a good or service for the second entity). The first entity (via the first client device) may indicate that the transactions at Store A and Store C are to be associated with the simulated account. In some implementations, the server device may determine one or more transactions that are to be associated with the simulated account without receiving such an indication from the first entity (e.g., based on a transaction device used to complete a transaction), as described in more detail below. This may conserve network resources that would otherwise be used to indicate this information.

In some implementations, the simulated account information may include an indication of whether the simulated account is to be associated with a transaction device (e.g., a transaction card). For example, a transaction device can be used by the first entity to complete transactions that are to be associated with the simulated account by the server device (and/or a transaction backend system). That is, the parent account may be associated with multiple transaction devices (e.g., multiple transaction cards). If the first entity completes a transaction using a first transaction device, then the server device may associate the transaction with only the parent account (e.g., information associated with the transaction may only be accessible by the first entity). If the first entity completes a transaction using a second transaction device, then the server device may associate the transaction with the parent account and the simulated account (e.g., information associated with the transaction may be accessible by the first entity and the second entity). In some implementations, the simulated account information may include an indication of whether the second entity (via a transaction device associated with the simulated account) is enabled to initiate and/or complete transactions associated with the simulated account. For example, the first entity may enable the second entity to initiate transactions (e.g., via a transaction device associated with the simulated account, such as the second transaction device described above) that are to be associated with the simulated account, as described in more detail below.

In some implementations, the first client device may transmit, to the server device, one or more rules indicating the information to be associated with the simulated account. For example, a rule may include a type of transaction, a category of transactions, an identifier of a transaction device (e.g., indicating that transactions associated with the transaction device are to be associated with the simulated account), a maximum transaction amount, and/or minimum transaction amount among other examples. The server device may store the one or more rules (e.g., in a rules engine). The server device may use the one or more rules to identify the information (e.g., from the parent account) that is to be associated with the simulated account. In this way, the server device may dynamically identify information (e.g., from the parent account) that is to be associated with the simulated account without an explicit indication from the first client device (e.g., by using the one or more rules).

In some implementations, the server device may identify and/or suggest information (e.g., from the parent account) to be associated with the simulated account. For example, the server device may analyze other or past simulated accounts associated with the parent account, simulated accounts associated with different parent accounts, and/or information associated with the parent account to identify information to be associated with the simulated account. The server device may transmit, to the first client device, an indication of suggested information to be associated with the simulated account. The server device may receive, from the first client device, a response confirming or modifying the suggested information to be associated with the simulated account. The server device may store the confirmed and/or modified information to be associated with the simulated account. In some implementations, the server device may use the confirmation and/or modification of the suggested information to be associated with the simulated account to make future suggestions for information to be associated with future simulated accounts (e.g., associated with the parent account or a different parent account). In this way, the server device may conserve network resources and/or processing resources that would otherwise be used by the first client device and/or the server device to identify and/or indicate information to be associated with simulated accounts.

In some implementations, the server device may link or pair the simulated account and the parent account in a database that stores account information (e.g., an account database). In some implementations, the server device may indicate types or categories of information that is to be made available to the simulated account. The server device may automatically update certain simulated account information if information is updated in the parent account. For example, if certain types of transactions (e.g., at a particular entity or merchant and/or made using a transaction device associated with the simulated account) are completed using resources of the parent account, then the server device may store the transaction information as being associated with the parent account and the simulated account.

As shown by reference number 125, the server device may create a platform that enables the second entity (via the second client device) to access or interact with the simulated account information. The platform may be based on or may simulate (e.g., mimic) a platform used by the first entity to access the parent account. For example, the server device may create the platform that is based on the platform provided by the institution associated with the parent account. The platform may be a digital environment, an application, and/or a webpage (or multiple webpages), among other examples. The platform may include an interface (e.g., a graphical user interface) that enables the second entity to access and interact with (via the second client device) the information provided via the platform. For example, the platform may include an interface that enables the second entity to access a statement or a record of transactions associated with the simulated account, account information associated with the simulated account, and/or an input that enables the second entity to submit a payment (e.g., towards an account balance of the simulated account), among other examples.

In some implementations, the server device may store information associated with the parent account (e.g., in a database) such that information that is to be provided to the simulated account is indicated or otherwise flagged. In some implementations, the parent account may be associated with multiple simulated accounts (e.g., that are to be provided different information associated with the parent account. Therefore, the server device may store information associated with the parent account (e.g., in a database) such that information that is to be provided to each simulated account is indicated or otherwise flagged. In this way, when an entity, such as the second entity, provides login credentials to access a simulated account, the server device may quickly identify and/or retrieve the information associated with the parent account that is to be provided to the simulated account.

As shown by reference number 130, the server device may provide the platform for the simulated account to the second client device. For example, the second entity may log in to the platform on the second client device using credentials for the simulated account. The platform may display, on the second client device, the information associated with the simulated account (e.g., that is based on the information associated with the parent account). For example, as shown in FIG. 1A, the platform may display or indicate an interest rate (e.g., 15%), an account balance (e.g., $165, that is based on the transactions (at Store A and Store C) that are made available to the simulated account), a budget or allowance (e.g., $200), a payment due date (e.g., the 1^{st} of every month), and/or a statement or record of transactions associated with the simulated account, among other examples. Additionally, certain information associated with the parent account may not be displayed or indicated by the platform (e.g., may be hidden, blurred, or otherwise not viewable on the second client device). For example, as shown in FIG. 1A, a limit (e.g., a credit limit or a spending limit) associated with the parent account may not be displayed by the platform. Similarly, certain transactions associated with the parent account, such as the transaction at Store B for $67, may not be displayed by the platform when accessed by the second entity using the second client device.

For example, the first entity may input a $200 budget for the simulated account that can be used by the second entity to make payments or contributions towards the account balance of the simulated account. In some implementations, the budget of the simulated account may be based on simulated resources (e.g., the server device may simulate resources for the simulated account). In some implementations, the budget of the simulated account may be based on resources of the parent account. For example, the server device may deduct or reserve resources (e.g., $200) from the resources of the parent account based on the budget of the simulated account. In this way, when the second entity submits a payment via the platform, the payment can be applied to an account balance of the parent account, as described in more detail below.

As described above, the information displayed via the platform may be based on information associated with the parent account. For example, the server device may retrieve and/or identify account information and/or transaction data associated with the parent account (e.g., that is to be associated with the simulated account) and may provide the account information and/or transaction data to the second client device via the platform to enable the second entity to access and interact with the account information and/or transaction data in a simulated manner. In this way, the simulated account may be based on real world transactions and/or account information, enabling the second entity to manage the simulated account based on the real world transaction and/or account information, as described in more detail below.

As shown in FIG. 1B, and by reference number 135, the server device may receive an indication of a transaction to be associated with the simulated account, such as a transaction at Store D for $30. In some implementations, the first entity may provide the indication of the transaction to the server device via the first client device. For example, the first entity may provide an input to the first client device that the transaction is to be associated with the simulated account and the first client device may transmit an indication to the server device that the transaction is to be associated with the simulated account.

In some implementations, the server device may identify (or receive an indication from the transaction backend system of) the transaction. For example, the first entity and/or the second entity may complete the transaction using a transaction device that is associated with the simulated account (e.g., a simulated account transaction device, such as the second transaction device described above). The server device may determine that the transaction is to be associated with the simulated account based on identifying that the transaction was initiated using the simulated account transaction device.

In some implementations, the transaction may be completed using resources associated with the parent account. In some implementations, the server device and/or the transaction backend system may determine whether to approve the transaction based on the simulated account information. For example, the first entity may provide an input of one or more transaction conditions for the simulated account, such as a spending limit, approved categories, and/or approved entities or merchants, among other examples. The server device and/or the transaction backend system may determine whether the transaction satisfies the one or more transaction conditions. If the transaction satisfies the one or more transaction conditions, then the server device and/or the transaction backend system may complete the transaction using resources of the parent account and associate the transaction data (e.g., transaction time, transaction date, transaction amount, and/or merchant) with both the parent account and the simulated account. If the transaction does not satisfy the one or more transaction conditions, then the server device and/or the transaction backend system may deny the transaction.

In some implementations, upon receiving the indication of the transaction initiated using the simulated account transaction device, the server device may transmit an indication to the first client device (or another device of the first entity, such as a mobile device) requesting the first entity to confirm the transaction. The request to confirm that transaction may indicate transaction details (e.g., time, date, place, merchant, and/or amount) and/or that the transaction is associated with the simulated account. If the server device receives an indication from the first client device confirming or approving the transaction, then the server device and/or the transaction backend may complete the transaction using resources of the parent account (or enable the transaction to be completed upon a subsequent attempt to complete the transaction). If the server device receives an indication from the first client device denying the transaction, then the server device may decline or not complete the transaction. In some implementations, if the server device determines that the transaction is initiated using the simulated account transaction device, then the server device may automatically decline the transaction.

As shown by reference number 140, the server device may update information for the simulated account based on the indication of the transaction. For example, if the transaction is completed (e.g., using resources associated with the parent account), then the server device may associate transaction details of the transaction with the simulated account (e.g., and the parent account). For example, the server device may add the transaction to a statement or record of transactions associated with the simulated account and/or may update an account balance of the simulated account, among other examples. The server device may maintain a database of transactions associated with the parent account. If the server device determines that a transaction (completed using resources of the parent account) is to be associated with the simulated account, then the server device may update the database to indicate that the transaction is associated with the parent account and the simulated account. In this way, when the server device retrieves and/or identifies information to be provided to the platform associated with the simulated account, the server device may identify real world transaction details and provide the real world transaction details to the platform associated with the simulated account.

In some implementations, if the server device declines the transaction (e.g., automatically or based on an indication from the first client device), then the server device may still track the transaction details of the transaction and may associate them with the simulated account. For example, the second entity may initiate a transaction at Store D for $30. The server device may decline the real world transaction at Store D (e.g., for $30), but the server device may associate the transaction at Store D with the simulated account and may display the transaction details in the account information of the simulated account. For example, the server device (and/or the transaction backend system) will not complete the transaction using resources associated with the parent account, but the server device may update a database associated with the simulated account to include the transaction details of the transaction. In this way, when the server device retrieves and/or identifies information to be provided to the platform associated with the simulated account, the server device may identify real world transaction details and provide the real world transaction details to the platform associated with the simulated account. Therefore, the second entity may be enabled to initiate real world transactions and track and/or manage the real world transactions via the simulated account without the consequences associated with actually completing the transactions. In this way, the second entity may be enabled to realize the consequences of completing the transactions and may avoid the negative effects of actually completing such transactions. This may conserve computing resources that would have otherwise been used by the second entity to remedy such transactions (e.g., had they been completed using resources of an account associated with the second entity).

In some implementations, the server device may update information for the simulated account in a similar (or the same) manner as a real world transaction account, such as the parent account. For example, the server device may apply fees, may calculate interest, and/or may calculate and/or apply reward points, among other examples, for the simulated account. The server device may update the information for the simulated account based on the real world transactions, as described above. For example, at a certain date each month, the server device may identify an account balance of the simulated account. The server device may apply an interest rate to the account balance to calculate interest to be applied to the account balance. The server device may update the account balance by adding the calculated interest. In this way, the account balance of the simulated account may be updated in a similar manner to the parent account, enabling the second entity to realize the effects of maintaining an account balance in the simulated account.

As shown by reference number 145, the server device may provide the updated information for the simulated account to the second client device (e.g., via the platform). As shown by reference number 150, the second entity may access the platform via the second client device to view the updated information for the simulated account. For example, as shown in FIG. 1B, the platform may display an updated balance of $195 with the addition of the transaction at Store D (e.g., based on the previous account balance of $165 plus the new transaction of $30). The second entity may be enabled to interact with the updated information via the platform on the second client device. As a result, the second entity may access and interact with the real world transaction information in the simulated environment provided by the platform.

As shown in FIG. 1C, and by reference number 155, the second entity may interact with the platform to submit a payment or contribution towards an account balance of the simulated account. For example, the second entity may input a payment amount (e.g., $50 as shown in FIG. 1C) into the platform via the second client device. In some implementations, the payment amount may be from the budget of the simulated account. For example, as shown in FIG. 1C, the budget of the simulated account may be $200. In some implementations, the $200 budget may be a simulated budget (e.g., based on simulated resources). In some implementations, the $200 budget may be based on real resources. For example, rather than provide the second entity with cash, the first entity may set a $200 budget for the simulated account, which is based on resources of the parent account. In some implementations, the first entity may provide the second entity with a monthly allowance of $200 that is automatically provided to the simulated account via the server device each month (e.g., and is based on resources of the parent account or another account associated with the first entity). In some implementations, the $200 budget may be based on resources provided to the first entity by the second entity. For example, the second entity may provide the first entity with $200 in cash and the first entity may set the budget of the simulated account at $200. The second entity may submit a payment of $50, from the $200 budget, to pay towards the account balance of the simulated account (e.g., $195 as shown in FIG. 1C). In some implementations, the payment may be for a specific transaction and/or a set of transactions associated with the simulated account. For example, the payment may be towards the amount of the transaction at Store C (e.g., $120), rather than the total account balance of the simulated account.

As shown by reference number 160, the second client device may transmit an indication of the payment to the server device. For example, the client device may receive an input from the second entity indicating the payment (e.g., via the platform, as described above). The second client device may transmit an indication of the payment (e.g., an amount of the payment) to the server device.

In some implementations, as shown by reference number 165, the server device may transmit, to the first client device, a request to confirm the payment. The request to confirm the payment may indicate the payment amount (e.g., $50), a time and/or date of the payment, a current account balance of the simulated account, and/or one or more transactions associated with the payment, among other examples. As shown by reference number 170, the first client device may receive an input from the first entity confirming the payment. The first client device may transmit an indication of the confirmation the payment to the server device.

As shown by reference number 175, the server device may update account information for the simulated account and/or the parent account based on the payment. In some implementations, the server device may update the account information based on receiving the confirmation of the payment from the first client device, as described above. The server device may update an account balance of the simulated account (e.g., from $195 to $145 based on the $50 payment) in a database stored by the server device. In some implementations, the server device may apply the payment to an account balance of the parent account. For example, the budget of the simulated account may be based on resources of the parent account, as described above. In other words, the server device may reserve resources of the parent account based on the budget of the simulated account. When a payment is submitted that is associated with the simulated account, the server device may associate the payment with the resources of the parent account and may apply the amount of the payment to the account balance of the parent account (e.g., reducing the account balance from $1,500 to $1,450 based on the $50 payment as shown in FIG. 1C) in addition to updating the account balance of the simulated account.

In some implementations, the server device may determine whether the payment submitted by the second entity via the second client device is timely. For example, the simulated account may be associated with a payment due date and/or a minimum payment. The server device may determine if the payment submitted by the second entity is made by the due date and/or satisfies the minimum payment. In some implementations, if the server device determines that the payment is made on time (e.g., by the due date) and/or satisfies the minimum payment, then the server device may provide a benefit to the simulated account. For example, the benefit may include increasing the budget of the simulated account, reducing an interest rate, and/or applying reward points, among other examples. If the server device determines that the payment is not made on time and/or does not satisfy the minimum payment, then the server device may apply a penalty to the simulated account. For example, the penalty may include decreasing the budget of the simulated account, increasing the interest rate, and/or deducting reward points, among other examples.

In some implementations, the server device may track a payment history associated with the simulated account to determine a score associated with the simulated account. The score may be similar to a credit score or a credit worthiness score. For example, if the payment history associated with the simulated account indicates a threshold number of on-time payments and/or a threshold number of consecutive on-time payments, then the server device may increase the score. If the payment history indicates a late payment or a missed payment, then the server device may decrease the score. In this way, the server device may provide an indication to the second entity of the impact of making on-time payments associated with the simulated account. In some implementations, the server device may use the score to determine a credit worthiness of the second entity if the second entity applies for an actual transaction account, as described in more detail below.

In some implementations, the first entity may submit payments or contributions towards an account balance of the parent account (e.g., for one or more transactions that are also associated with the simulated account) without relying on a payment from the simulated account. For example, the first entity may be enabled to submit payments and/or manage the parent account via the first client device. A payment towards the account balance of the parent account submitted by the first entity may not change an account balance of the simulated account. In this way, the first entity may be enabled to manage the parent account (e.g., and avoid missing payments associated with the parent account), while still enabling the second entity to manage the simulated account based on the real world transactions completed using resources of the parent account. This may conserve computing resources that would have otherwise been used to identify and/or remedy a missed payment if the parent account were to rely on a payment from the simulated account.

As shown in FIG. 1D, and by reference number 180, the first client device and/or the second client device may transmit an indication to the server device to convert the simulated account into an actual account. An actual account may refer to an account that is associated with resources (e.g., similar to the parent account) and/or an authorized user account associated with the parent account. In some implementations, the actual account may be separate and distinct from the parent account (e.g., the actual account may have a separate account identifier, separate resources, separate terms, separate account information, and/or a separate transaction log). In some implementations, when the second entity reaches a certain age, such as 18, the second entity may be allowed (e.g., by regulation or a policy of the institution providing transaction accounts) to apply for a transaction account. The second entity may transmit an application for a transaction account via the second client device requesting that the simulated account be converted to the transaction account.

In some implementations, the first entity may determine, based on monitoring a use of the simulated account by the second entity, that the second entity should be added as an authorized user associated with the parent account (e.g., enabling the second entity to complete transactions using resources of the parent account without approval from the first entity). For example, the first entity may determine that the second entity has shown a level of trustworthiness or responsibility in the use of the simulated account (e.g., by making on time payments). The first entity may transmit an application, via the first client device, to convert the simulated account into an authorized user account.

As shown by reference number 185, the server device may determine whether to approve the request to convert the simulated account into an actual account. In some implementations, the server device may determine whether to approve the request based on application information provided in the request to convert the simulated account, such as a name of the second entity, geographic information associated with the second entity (e.g., an address, a city, a state, and/or a postal code, among other examples), a date of birth of the second entity, and/or a social security number of the second entity, among other examples. In some implementations, the server device may determine whether to approve the request based on a history of use of the simulated account by the second entity. For example, the server device may analyze a payment history or a score of the simulated account, as described above. The server device may determine whether to approve (and/or may determine a spending limit, a credit limit, and/or an interest rate to be associated with the converted account) based on the payment history or the score of the simulated account. This may enable the server device to make improved decisions regarding whether to approve applicants for a transaction account (e.g., by using the history of use of a simulated account by an applicant).

As shown by reference number 190, the server device may create an actual account associated with the second entity if the request is approved. The server device may create the actual account using information associated with the simulated account. For example, the server device may retrieve and/or identify information associated with the simulated account in a transaction account database. The server device may use the simulated account information to create the actual account. In some implementations, the server device may create the actual account with a new account identifier or credential. In some implementations, the server device may create the actual account with the same account identifier or credential that is associated with the simulated account. As a result, an amount of time associated with creating the actual account may be reduced and computing resources may be conserved by the server device that would have otherwise been used to create the actual account without the simulated account information.

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include a transaction terminal 210, a transaction device 220, a mobile device 230, a transaction backend system 240, a network 250, a server device 260, and/or a client device 270. Devices of environment 200 may interconnect via wired connections and/or wireless connections.

The transaction terminal 210 includes one or more devices capable of facilitating an electronic transaction associated with the transaction device 220. For example, the transaction terminal 210 may include a point-of-sale (PoS) terminal, a payment terminal (e.g., a credit card terminal, a contactless payment terminal, a mobile credit card reader, or a chip reader), and/or an automated teller machine (ATM). The transaction terminal 210 may include one or more input components and/or one or more output components to facilitate obtaining data (e.g., account information) from the transaction device 220 and/or to facilitate interaction with and/or authorization from an owner or accountholder of the transaction device 220. Example input components of the transaction terminal 210 include a number keypad, a touchscreen, a magnetic stripe reader, a chip reader, and/or a radio frequency (RF) signal reader (e.g., a near-field communication (NFC) reader). Example output devices of transaction terminal 210 include a display and/or a speaker.

The transaction device 220 includes one or more devices capable of being used for an electronic transaction. In some implementations, the transaction device 220 includes a transaction card (or another physical medium with integrated circuitry) capable of storing and communicating account information, such as a credit card, a debit card, a gift card, an ATM card, a transit card, a fare card, and/or an access card. In some implementations, the transaction device 220 may be the mobile device 230 or may be integrated into the mobile device 230. For example, the mobile device 230 may execute an electronic payment application capable of performing functions of the transaction device 220 described herein. Thus, one or more operations described herein as being performed by the transaction device 220 may be performed by a transaction card, the mobile device 230, or a combination thereof.

The transaction device 220 may store account information associated with the transaction device 220, which may be used in connection with an electronic transaction facilitated by the transaction terminal 210. The account information may include, for example, an account identifier that identifies an account (e.g., a bank account or a credit account) associated with the transaction device 220 (e.g., an account number, a card number, a bank routing number, and/or a bank identifier), a cardholder identifier (e.g., identifying a name of a person, business, or entity associated with the account or the transaction device 220), expiration information (e.g., identifying an expiration month and/or an expiration year associated with the transaction device 220), and/or a credential (e.g., a payment token). In some implementations, the transaction device 220 may store the account information in tamper-resistant memory of the transaction device 220, such as in a secure element. As part of performing an electronic transaction, the transaction device 220 may transmit the account information to the transaction terminal 210 using a communication component, such as a magnetic stripe, an integrated circuit (IC) chip (e.g., a EUROPAY®, MASTERCARD®, VISA® (EMV) chip), and/or a contactless communication component (e.g., an NFC component, an RF component, a Bluetooth component, and/or a Bluetooth Low Energy (BLE) component). Thus, the transaction device 220 and the transaction terminal 210 may communicate with one another by coming into contact with one another (e.g., using a magnetic stripe or an EMV chip) or via contactless communication (e.g., using NFC).

The mobile device 230 includes one or more devices capable of being used for an electronic transaction, as described above in connection with the transaction device 220. The mobile device 230 may include a communication device and/or a computing device. For example, the mobile device 230 may include a wireless communication device, a mobile phone, a user equipment, a tablet computer, a wearable communication device (e.g., a smart wristwatch, a pair of smart eyeglasses, a head mounted display, or a virtual reality headset), or a similar type of device.

The transaction backend system 240 includes one or more devices capable of processing, authorizing, and/or facilitating a transaction. For example, the transaction backend system 240 may include one or more servers and/or computing hardware (e.g., in a cloud computing environment or separate from a cloud computing environment) configured to receive and/or store information associated with processing an electronic transaction. The transaction backend system 240 may process a transaction, such as to approve (e.g., permit, authorize, or the like) or decline (e.g., reject, deny, or the like) the transaction and/or to complete the transaction if the transaction is approved. The transaction backend system 240 may process the transaction based on information received from the transaction terminal 210, such as transaction data (e.g., information that identifies a transaction amount, a merchant, a time of a transaction, a location of the transaction, or the like), account information communicated to the transaction terminal 210 by the transaction device 220, and/or information stored by the transaction backend system 240 (e.g., for fraud detection).

The transaction backend system 240 may be associated with a financial institution (e.g., a bank, a lender, a credit card company, or a credit union) and/or may be associated with a transaction card association that authorizes a transaction and/or facilitates a transfer of funds. For example, the transaction backend system 240 may be associated with an issuing bank associated with the transaction device 220, an acquiring bank (or merchant bank) associated with the merchant and/or the transaction terminal 210, and/or a transaction card association (e.g., VISA® or MASTERCARD®) associated with the transaction device 220. Based on receiving information associated with the transaction device 220 from the transaction terminal 210, one or more devices of the transaction backend system 240 may communicate to authorize a transaction and/or to transfer funds from an account associated with the transaction device 220 to an account of an entity (e.g., a merchant) associated with the transaction terminal 210.

The network 250 includes one or more wired and/or wireless networks. For example, the network 250 may include a cellular network, a public land mobile network, a local area network, a wide area network, a metropolitan area network, a telephone network, a private network, the Internet, and/or a combination of these or other types of networks. The network 250 enables communication among the devices of environment 200. In some implementations, the transaction terminal 210 may communicate with the transaction device 220 using a first network (e.g., a contactless network or by coming into contact with the transaction device 220) and may communicate with the transaction backend system 240 using a second network.

The server device 260 includes one or more devices capable of receiving, generating, storing, processing, providing, and/or routing information associated with creating, updating, and/or providing a platform for a simulated account that is based on a real world account, as described elsewhere herein. The server device 260 may include a communication device and/or a computing device. For example, the server device 260 may include a server, such as an application server, a client server, a web server, a database server, a host server, a proxy server, a virtual server (e.g., executing on computing hardware), or a server in a cloud computing system. In some implementations, the server device 260 includes computing hardware used in a cloud computing environment.

The client device 270 includes one or more devices capable of receiving, generating, storing, processing, and/or providing information associated with requesting, accessing, and/or managing a simulated account that is based on a real world account, as described elsewhere herein. The client device 270 may include a communication device and/or a computing device. For example, the client device 270 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to transaction terminal 210, transaction device 220, mobile device 230, transaction backend system 240, server device 260, and/or client device 270. In some implementations, transaction terminal 210, transaction device 220, mobile device 230, transaction backend system 240, server device 260, and/or client device 270 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

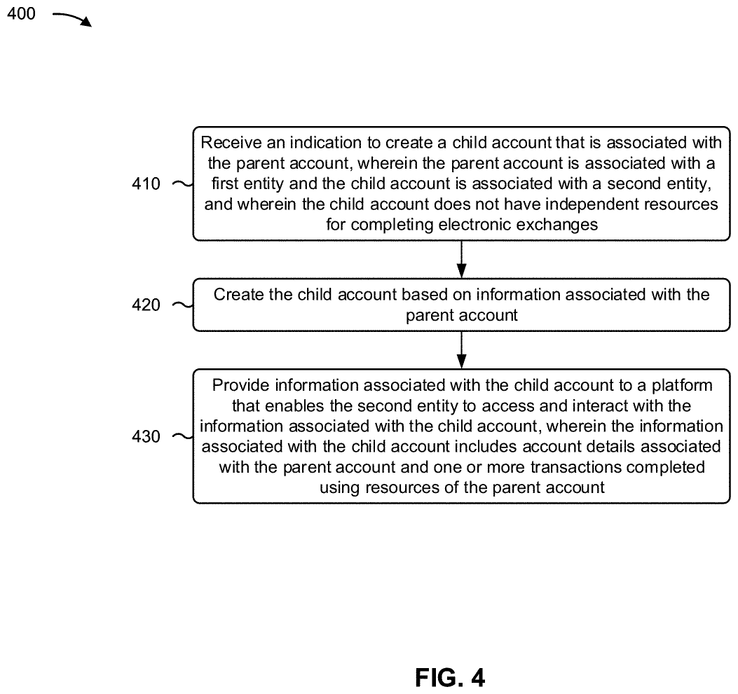

FIG. 4 is a flowchart of an example process 400 associated with a simulated account based on a real world account. In some implementations, one or more process blocks of FIG. 4 may be performed by a device (e.g., server device 260). In some implementations, one or more process blocks of FIG. 4 may be performed by another device or a group of devices separate from or including the device, such as transaction terminal 210, transaction device 220, mobile device 230, transaction backend system 240, and/or client device 270. Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include receiving an indication to create a child account that is associated with the parent account (block 410). In some implementations, the parent account is associated with a first entity and the child account is associated with a second entity, and the child account does not have independent resources for completing electronic exchanges. As further shown in FIG. 4, process 400 may include creating the child account based on information associated with the parent account (block 420). As further shown in FIG. 4, process 400 may include providing information associated with the child account to a platform that enables the second entity to access and interact with the information associated with the child account (block 430). In some implementations, the information associated with the child account includes account details associated with the parent account and one or more transactions completed using resources of the parent account.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for simulating an environment based on a first account, the system comprising:
one or more memories; and
one or more processors, communicatively coupled to the one or more memories, configured to:
receive, from a first device associated with a first entity, a request to create a simulated account associated with the first account, wherein the first account is associated with the first entity and the simulated account is associated with a second entity;
create the simulated account and a simulated environment associated with the simulated account, wherein the simulated environment includes an interface that enables the second entity to access or interact with information associated with the first account;
receive an indication of information associated with the first account that is to be made available to the simulated account, wherein the information includes at least one of:
one or more attributes of the first account, or
one or more exchanges that are associated with the first account; and
provide, to a second device associated with the second entity, the simulated environment associated with the simulated account indicating the information associated with the first account.

2. The system of claim 1, wherein the one or more processors are further configured to:
receive, from the first device, an indication of resources to be allocated to the simulated account; and
receive, from the second device via the simulated environment, a contribution towards an account balance of the simulated account using the resources.

3. The system of claim 2, wherein the resources to be allocated to the simulated account are based on resources of the first account.

4. The system of claim 1, wherein the one or more processors are further configured to:
receive an indication of a transaction associated with the simulated account that is initiated using a transaction device associated with the simulated account;
provide, to the first device, a request to confirm the transaction; and
complete, based on receiving confirmation of the transaction from the first device, the transaction using resources of the first account.

5. The system of claim 1, wherein the one or more processors, when receiving the indication of the information associated with the first account that is to be made available to the simulated account, are configured to:
receive an indication of a transaction, completed using resources of the first account, that is to be included in the simulated environment, wherein the indication includes:
an indication that the transaction was completed using a transaction device that is associated with the simulated account, or
an indication received from the first device; and
provide, to the simulated environment, an indication of the transaction.

6. The system of claim 1, wherein the one or more processors are further configured to:
receive, from the second device via the simulated environment, a contribution towards an account balance associated with the simulated account,
wherein the account balance associated with the simulated account is based on one or more transactions completed using resources of the first account;
provide, to the first device, a request to confirm the contribution; and
apply the contribution to an account balance of the first account based on receiving a confirmation of the contribution from the first device.

7. The system of claim 1, wherein the one or more processors are further configured to:
receive application information associated with an application to convert the simulated account to an actual account associated with the second entity,
wherein the actual account is an authorized user account associated with the first account or a second account;
determine whether to approve the application based on at least one of the application information or information associated with the simulated account; and
create the actual account associated with the second entity based on determining to approve the application.

8. A method for simulating a parent account, comprising:
receiving, by a device, an indication to create a child account that is associated with the parent account,
wherein the parent account is associated with a first entity and the child account is associated with a second entity, and
wherein the child account does not have independent resources for completing electronic exchanges;
creating, by the device, the child account based on information associated with the parent account; and
providing, by the device, information associated with the child account to a platform that enables the second entity to access and interact with the information associated with the child account,
wherein the information associated with the child account includes account details associated with the parent account and one or more transactions completed using resources of the parent account.

9. The method of claim 8, wherein the account details associated with the parent account include at least one of:
a transaction limit,
a contribution deadline, or
an interest rate.

10. The method of claim 8, further comprising:
receiving an indication of an amount of simulated resources to be made available to the child account; and
receiving, via the platform, a contribution towards an account balance of the child account using the simulated resources, wherein the account balance of the child account is based on the one or more transactions completed using the resources of the parent account.

11. The method of claim 10, further comprising:
determining whether the contribution satisfies a contribution deadline associated with the child account; and
performing an action based on whether the contribution satisfies the contribution deadline, wherein the action includes:
increasing the amount of the simulated resources or applying a reward benefit to the child account if the contribution satisfies the contribution deadline, or
decreasing the amount of the simulated resources if the contribution does not satisfy the contribution deadline.

12. The method of claim 8, further comprising:
receiving an indication of a transaction initiated by an identifier associated with the child account;
denying the transaction; and
providing information associated with the transaction to the platform.

13. The method of claim 8, wherein the platform is associated with an institution that is associated with the parent account.

14. The method of claim 8, further comprising:
receiving an indication of the information associated with the child account that is to be provided to the platform.

15. The method of claim 8, further comprising:
receiving a request to convert the child account into an account that has resources for completing transactions;
identifying information associated with the child account and the second entity; and
converting the child account into the account that has resources for completing transactions based on the information associated with the child account.

16. A non-transitory computer-readable medium storing a set of instructions, the set of instructions comprising:
one or more instructions that, when executed by one or more processors of a device, cause the device to:
establish, via a server device, a connection with a simulated platform for accessing or interacting with information associated with an account,
wherein the information associated with the account includes at least one of account details associated with the account or one or more records associated with the account,
wherein the account is associated with a first entity and a credential used to access the simulated platform is associated with a second entity;
display, via an interface of the device, the simulated platform indicating the information associated with the account;
receive, from the server device, updated information associated with the account; and
display, via the interface of the device, the simulated platform indicating the updated information associated with the account.

17. The non-transitory computer-readable medium of claim 16, wherein the one or more instructions, when executed by the one or more processors, further cause the device to:
receive, via the simulated platform, an input, wherein the input includes at least one of:
an indication of a contribution towards an account balance of the account indicated by the simulated platform, wherein the account balance is based on the one or more records associated with the account, or
an indication of a transaction to be completed using resources of the account; and
provide, to the server device, an indication of the input received via the simulated platform.

18. The non-transitory computer-readable medium of claim 16, wherein the one or more instructions, that cause the device to receive the updated information associated with the account, cause the device to:
receive, from the server device, an indication of a transaction completed using resources of the account that is to be indicated in the simulated platform,
wherein the updated information includes information associated with the transaction and an updated account balance of the account.

19. The non-transitory computer-readable medium of claim 18, wherein the transaction is initiated using a transaction device or an identifier associated with the simulated platform.

20. The non-transitory computer-readable medium of claim 16, wherein the one or more instructions, that cause the device to receive the updated information associated with the account, cause the device to:
receive, via the simulated platform, an indication of a contribution towards an account balance of the account, the contribution using resources indicated by the simulated platform;
provide, to the server device, an indication of the contribution towards the account balance of the account; and
receive, from the server device, an indication of an updated account balance of the account based on providing the indication of the contribution.
